(19) United States
(12) Patent Application Publication
(10) Pub. No.: US 2003/0229893 A1
(43) Pub. Date: Dec. 11, 2003

(54) Multiple response means for interactive advertising and information systems

(76) Inventor: Vito Sgaraglino, Las Vegas, NV (US)

Correspondence Address: Doug MacKenzie, 541 Del Medio Avenue 120, Mountain View, CA, 94040, US

(21) Appl. No.: 10/258,965

(22) PCT Filed: Apr. 26, 2001
(86) PCT No.: PCT/US01/13691

(51) Int. Cl. H04N 7/025; H04N 7/10; G06F 3/00; H04N 5/445; G06F 13/00; H04N 7/16

(52) U.S. Cl. 725/37; 348/563; 725/34; 725/42; 725/135; 725/106

(57) ABSTRACT

A system and method for providing information to a user in response to a user request. The method includes the steps of displaying an object, the object including a selectable area, receiving the user request responsive to selection of the selectable area, retrieving a user delivery address, retrieving information associated with the selectable area, and delivering the information to the user delivery address. The system includes a user interface, an object displayable on the user interface, an input device for selecting the object, a program operable to receive the user selection, address data associated with the user, information associated with the object, and a device operable to deliver the information to the address data.

### CROSS-REFERENCE TO RELATED APPLICATIONS

This application claims benefit of commonly owned International Application No. PCT/US01/13691 having international filing date Apr. 26, 2001 and earliest priority date Apr. 26, 2000, applicant Vito SGARAGLINO, and entitled “Multiple Response Means for Interactive Advertising And Information Systems,” which in turn claimed benefit of U.S. Provisional patent application 60/199,756. The disclosures of these two applications are incorporated herein by reference.

### BACKGROUND

1. Technical Field

This invention relates generally to the field of advertising and more specifically to the field of interactive advertising.

2. Prior Art

Internet advertising is a new and rapidly growing advertising medium. However, the response rate and effectiveness of Internet advertising has declined rapidly as the use of Internet advertisements has become more widespread and the initial novelty of such advertising has significantly subsided. Currently, the effectiveness of most Internet advertisements is measured by their “click rate”, this is, the ratio of the number of times the advertisements are clicked on by Internet users to the number of times the advertisements are viewed. As is well known in the art, Internet advertisements generally include banners having a link to another web page or site such that, by clicking on an Internet advertisement, a user's browser is directed to the other web page or site that then displays information or material that is particularly relevant to the advertisement.

Average click rates are currently on the order of 0.5 to 0.7%. In order to achieve higher rates, advertisers provide advertisements that are well targeted and placed in premium positions on related web pages. For these services, a substantial premium cost is typically paid by the organization placing the advertisement.

There are several reasons for the low click rate of Internet advertisements. Sophisticated Internet users have learned to ignore advertisements. They have done so in part because the number of advertisements has increased dramatically. Advertisements now permeate many web sites.

Advertisements are also typically poorly targeted. Users have, therefore, found that they rarely are rewarded with information of interest to them even when they take the time to notice an advertisement. The cost/reward ratio from the standpoint of the user is even worse when the user actually clicks on an advertisement. In this case, the user is detoured from their current browsing pattern and must wait for a new page to load. If the user finds that the information on the new page is not of interest to them, then they must browse back to the original page. The time and effort expended in detouring to the new page is a significant cost to the user and represents the primary,reasons for not clicking on an advertisement even if it is of some interest to the user.

If a user does click on an advertisement of interest, there are still a number of steps required for the advertisement to be of use to the advertiser. These are not accounted for in the measurement of click rates but are still of importance to the effectiveness of the advertisement. The user must look at the material on the new page to which he has been directed. Once the user looks at the material, the advertisement has achieved its first goal, that is, it has shown the user material supplied by the advertiser.

This result is similar to what a television or billboard advertisement seeks to accomplish. However, television and billboard advertisers depend on repeated impressions to convey a message to a target audience. Repeated impressions are difficult on the Internet due to the fact that most Internet advertisements are displayed on a rotating basis. Thus a particular advertisement may be displayed only once and for a few seconds at that in a given amount of time. Furthermore, the particular advertisement may only be displayed every nth time a visit to a particular site is initiated. Finally, users are unlikely to click on the same advertisement multiple times without a substantial reward.

Once clicked on, an Internet advertisement directs a user to a web page where the user can optionally take some action such as continuing to browse the information provided or place an order. In some cases however, the user is first taken to the advertiser's home page and must search further for the information the advertisement initially presented to the user. The need to search further provides an additional obstacle to the advertisement's effectiveness.

While at a web page providing relevant information to the user, the user must be willing to investigate, at that moment, the advertised offerings. Otherwise, the opportunity for the advertiser is lost.

Other disadvantages of prior art Internet advertising include the limited options available to the user for retaining the information provided in the advertisement. These options are limited to saving the Universal Resource Locator (URL) of the web page and saving, printing, or copying the web page. All of these take additional effort or knowledge on the user's part.

In this respect, Internet advertisement is similar to television advertisements that solicit the viewer to write down a phone number and make a phone call or visit a local retail outlet. In the case of television, advertisers conventionally give viewers many opportunities to respond as by displaying the advertisement periodically over the course of a predetermined period of time. As is well know in the advertising art, such efforts are necessary to elicit the desired response from the viewer.

With the introduction of interactive television, interactive radio, and interactive wireless devices including telephones, additional opportunities for advertisers exist. Thus, for example, advertisements tagged on to voice, e-mail, or other types of messages are known in the art. However, conventional advertising in these new media suffers from the same disadvantages of web page advertising.

The prior art includes order processing technology. For example, there are Internet technologies related to order processing that allow a user to purchase a product with single click on an object. Using these technologies, the user completes a pre-defined order form and selects a product prior to clicking the object and receives the product through the mail. Additionally, the user receives a confirming e-mail message without any further input from the user. However, prior to using the single click function, the user must make product selections. Furthermore, existing single click ordering systems function only from a dedicated web site, are used for purchasing products, and require user credit card or other billing information be provided before the single click.

There is a need for improved methods of response to interactive advertising and information system.

### SUMMARY OF THE INVENTION

Various embodiments of the invention include advertising response systems and methods that allow a user to request, using a single “click,” that follow-up information be sent to a delivery address. Some embodiments apply this concept to site independent single click ordering.

For example,various embodiments of the invention include system and method for providing information to a user in response to a user request is disclosed. The method includes the steps of displaying an object, the object including a selectable area, receiving the user request responsive to selection of the selectable area, retrieving a user delivery address, retrieving information associated with the selectable area, and delivering the information to the user delivery address.

In another example, various embodiments of the invention includes a user interface, an object displayable on the user interface, an input device for selecting the object, a program operable to receive the user selection, address data associated with the user, information associated with the object, and a device operable to deliver the information to the address data.

The foregoing and other embodiments, objects and advantages of the disclosed system and method will become apparent to those of ordinary skill in the art after having read the following detailed description of the several embodiments of the invention that are illustrated in the various drawing figures.

### BRIEF DESCRIPTION OF THE VARIOUS VIEWS OF THE DRAWING

FIG. 1 is a block diagram illustrating a system according to one embodiment of the invention;

FIG. 2 is a flowchart illustrating steps of a method according to various embodiments of the invention;

FIG. 3 is a block diagram illustrating a system according to various embodiments of the invention;

FIG. 4 is a flowchart illustrating steps of method according to various embodiments of the invention;

FIG. 5 is a block diagram illustrating a system according to some embodiments of the invention; and

FIG. 6 is a flowchart illustrating steps of a method according to some embodiments of the invention.

### DESCRIPTION OF THE PREFERRED EMBODIMENT

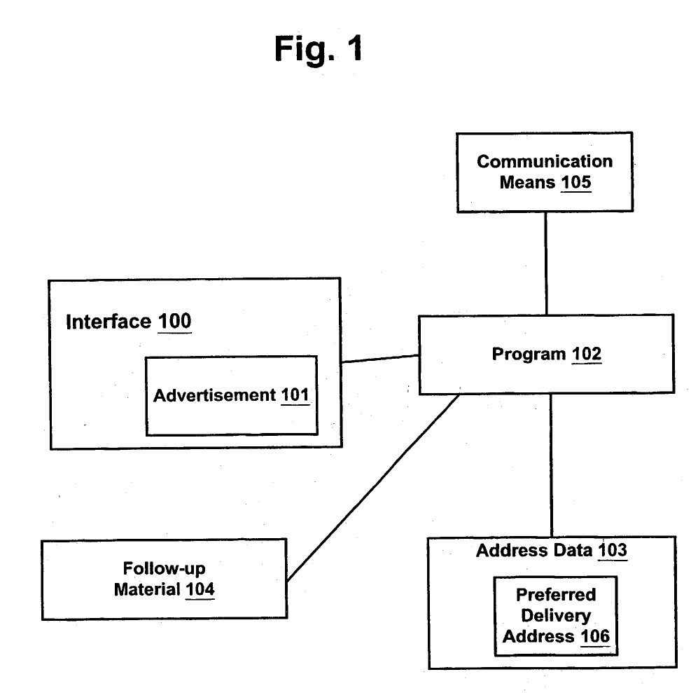

In various embodiments and as illustrated in FIG. 1, the system of the invention includes a user interface 100, an advertisement 101 conveyed to the user through the user interface 100, a program 102 responsive to user input, user address data 103 accessible by the program 102 and being configured to store at least one preferred delivery address 106, follow-up material 104 accessible by the program 102, and communication means 105. Follow-up material 104 optionally includes data such as text, images, video and audio. Communication means 105 is operable to deliver follow-up material 104 to the user at an address associated with the user and stored in user address data 103.

In various embodiments of the invention, user address data 103 includes user delivery address information entered prior to user input through user interface 100. Further, the program 102 provides means that allow the user to indicate if he or she is interested in the advertisement. In this manner, user input through user interface 100, including a single user request (e.g., click), is operable to direct program 102 to read the user address data 103 and to send the follow-up material 104 to the user address through communication means 105.

In some embodiments of the invention, communication means 105 is operable to send the follow-up material 104 to interfaces other than user interface 100.

In some embodiments of the invention, the user address data 103 and the follow-up material 104 are stored independently of one another.

In an embodiment of the invention, the interface 100 includes a web browser run on a personal computer and the advertisement 101 includes a display advertisement in the form of a bitmap. Further, the program 102 responsive to user input includes a Java-based software program and the address data 103 includes an e-mail address associated with the user and is stored on the user's personal computer in the form of a cookie or other such identifying technology. Follow-up material 104 includes a message describing the attributes of a product and communication means 105 includes an e-mail server for sending e-mail over the Internet.

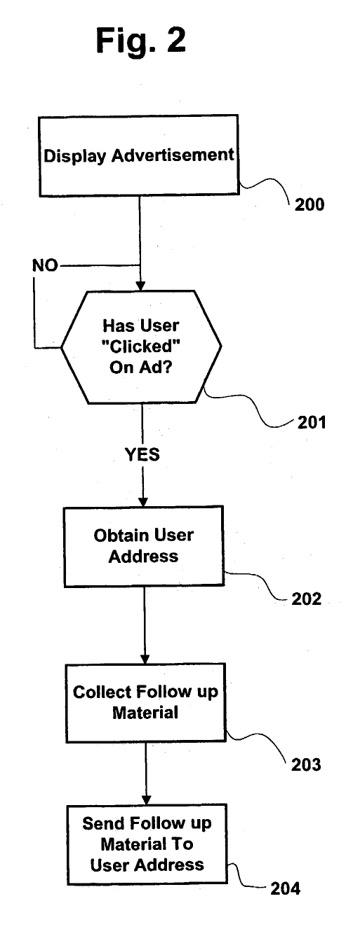

A method in accordance with various embodiments of the invention is illustrated in FIG. 2. In a first step 200, the advertisement 101 is conveyed to the user through the interface 100 and the program 102 is initiated. In a step 201 the program 102 determines if the user has indicated his interest in the advertisement such as by clicking on the advertisement 101. If the user has indicated his interest, the program 102 then retrieves the user address data 103 in a step 202. In a step 203 follow-up material 104 is collected and, in a step 204, the follow-up material 104 is sent through the communication means 105 using address data 103. Address data is typically associated with a location where the communicated follow-up material 104 is stored for the user's later use. In this manner the user can select when to view the information delivered. The delivery thereby does not interrupt their current activity.

In various embodiments of the invention, the recipient of the user request includes an entity independent of an entity displaying the object such as an object owner. For example, a system providing the advertisement 101 to interface 100 is optionally independent of a system including program 102, follow-up material 104, and/or address data 103.

In various embodiments of the invention, the user interface 100 includes an Internet browser having the functionality of step 201.

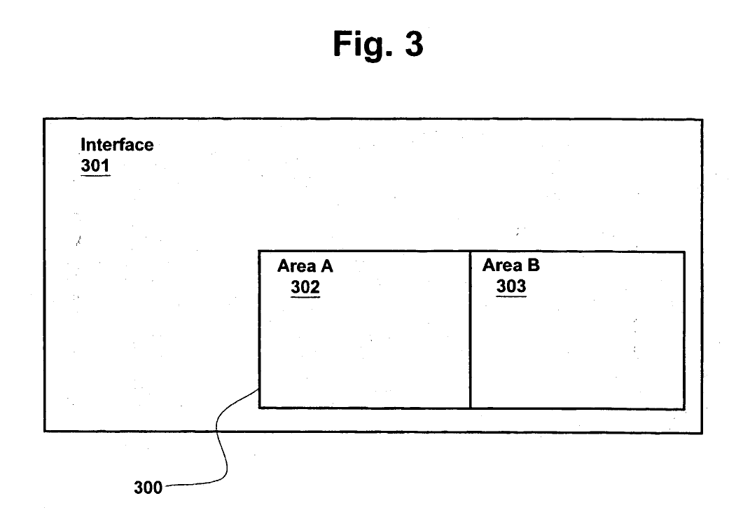

In some embodiments of the invention, as shown in FIG. 3, an interface 301 includes an interactive advertisement 300 comprising selectable inputs including at least one active area including active area 302 and optional active area 303. Active areas 302 and 303 provide the user with alternative means of responding to an advertisement. The active areas 302 and 303 are distinguishable from one another by their visual appearance and/or by their underlying function. When selected, each of the active areas 302 and 303 can initiate the execution of a different process as further described herein. Advertisement 300 is an embodiment of advertisement 101.

For example, in an embodiment of the invention, interface 301 includes an Internet browser and the interactive advertisement 300 includes an advertisement with two or more parts. The two or more parts of the advertisement use different color, image, text or other features (not shown) to distinguish the two or more active areas 302 and 303. When the user selects (e.g., clicks) either of the active areas 320 or 303, the program 102 is executed in accordance with the particular active area 302 or 303 selected. For instance, in some cases, selecting active area 302 results in delivery of follow-up material while selection of active area 303 results in redirection of a browser to a new location.

In various embodiments of the invention, interface 301 includes a television device such as an interactive television, a set-top box, digital converter, digital VCR and the like. In these embodiments, interactive advertisement 300 includes a video advertisement and the active areas 302 and 303 have spatial and/or temporal distinguishing attributes. Additionally, the television device includes an identification configured to identify the television device or requester such that an associated preferred delivery address 106 can be retrieved.

In some embodiments of the invention interactive advertisement 300 fits a standard advertisement design and can be loaded through a single reference.

In an embodiment of the invention, the interface 301 includes multiple modes of input to select active areas 302 and 303. These modes of input include, for example, alternate buttons on an input device (not shown), the ability to select alternative areas on the interface 301 itself, or the like.

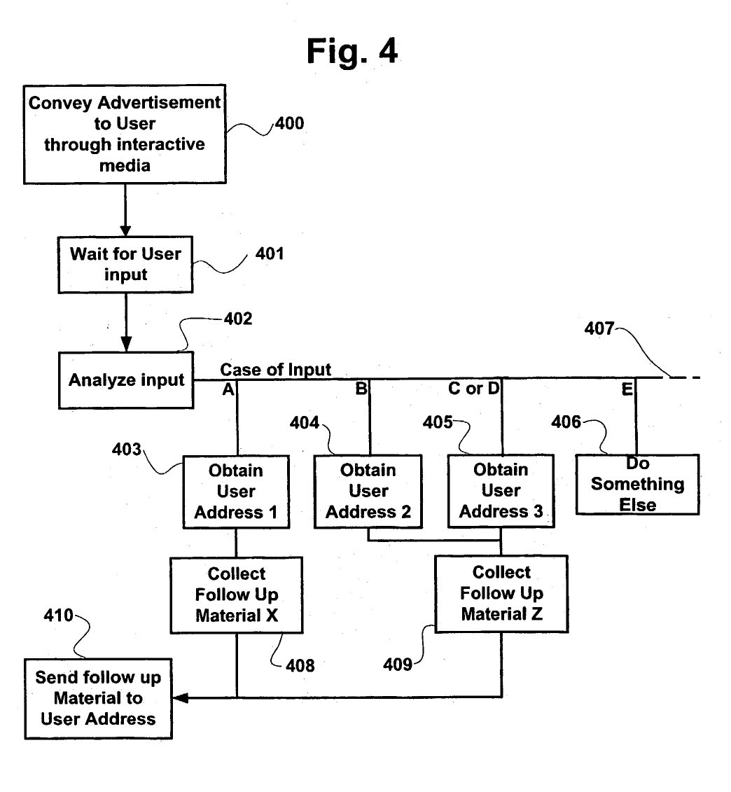

With reference to FIG. 4, a method in accordance with an embodiment of the invention is illustrated. In a first step 400 an advertisement is displayed to a user on a user interface such as interface 100. Next, in a step 401, user input is monitored. When user input is received, the input is analyzed by an algorithm in a step 402. This algorithm determines which of steps 403, 404, and/or 405 is used to obtain a user address and a communication means, or whether steps designated 406 and 407 are performed in which case the user address is not obtained. the algorithm is optionally responsive to the multiple modes of input, a region of advertisement 300 selected, the button pushed on selection, or the like method of indicating a choice on an interactive device. The user address obtained includes a user address obtained from address data 103. The communication means include e-mail, telephony, postal mail, a new version of interface 100, a file saved to storage media, or any other data transmission method.

After obtaining user address information, follow-up material 104 is collected in either a step 408 or a step 409 as determined by the algorithm. As indicated in FIG. 4 the follow-up material collected is optionally dependent upon the user address and sending means. Thus in step 408 follow-up material X is collected whereas in step 409 follow-up material Z is collected. Follow-up material is customizable as a function of information known about the user, the user address, the type of advertisement, the advertiser, the user interface, the date and time of day, the location of the advertisement, or the like. Finally, follow-up material is sent to the user address or addresses in a step 410.

In an embodiment of the invention user interface 100 includes a telephone and the advertisement 101 includes an audio message. In these embodiments the “displaying” of the advertisement is auditory rather than visual and includes playing of the audio. During and after the playing of the audio message the user has the option of pressing different buttons on the telephone keypad or responding by voice command. Pushing an optional button or speaking an optional voice command results in further information being played immediately over the telephone. Pushing a second button or speaking a second voice command results in information being mailed to the user via e-mail and/or the preferred delivery address 106. Pushing a third button or speaking a third command optionally does not interrupt the audio message or anything immediately following the audio message.

In various embodiments, interface 100 includes a wireless telephone, beeper, or other wireless device. The advertisement 101 includes a displayed text message or small image. Using the data entry features of the interface 100, the advertisement 101 is selectable. The follow-up material 104 is either delivered immediately through audio or text means or as a message to one or more preferred delivery addresses 106. The user address includes the cellular phone number or the wireless account number. Advantageously, such devices can be used to facilitate the delivery of large amounts of follow-up material 104 not conventionally accessible through the restricted bandwidth or displayable on the small displays of such devices. Furthermore, the inventive system and method of the invention provide for selection of an object, such as a small amount of text or audio component, and the consequent provision of a large amount of follow-up material 104 including text, graphics, video, or other data that is significantly larger than the object.

In various embodiments of the invention,.the user interface 100 includes an interactive television. The advertisement 101 includes a video message that may include selectable active areas or hot spots. During the playing of the video message the user has the option of pressing different buttons on an input control device. Pushing a first button results in follow-up material 104 being displayed upon the user interface 100 immediately. Pushing another button results in follow-up material 104 being provided to the user including being mailed to the user via e-mail, saved on a storage device coupled to the interactive television, (e.g., a digital VCR, digital converter, desk-top box or the like) or provided via other delivery means. Advantageously, user selection of active areas does not substantially interrupt the video display or anything that follows it. Alternatively, selection is enabled through pointing to or clicking on active areas or hot spots on the video image. These active areas or hot spots include functionality to associate each active area or hot spot with specific items including a piece of clothing or the like.

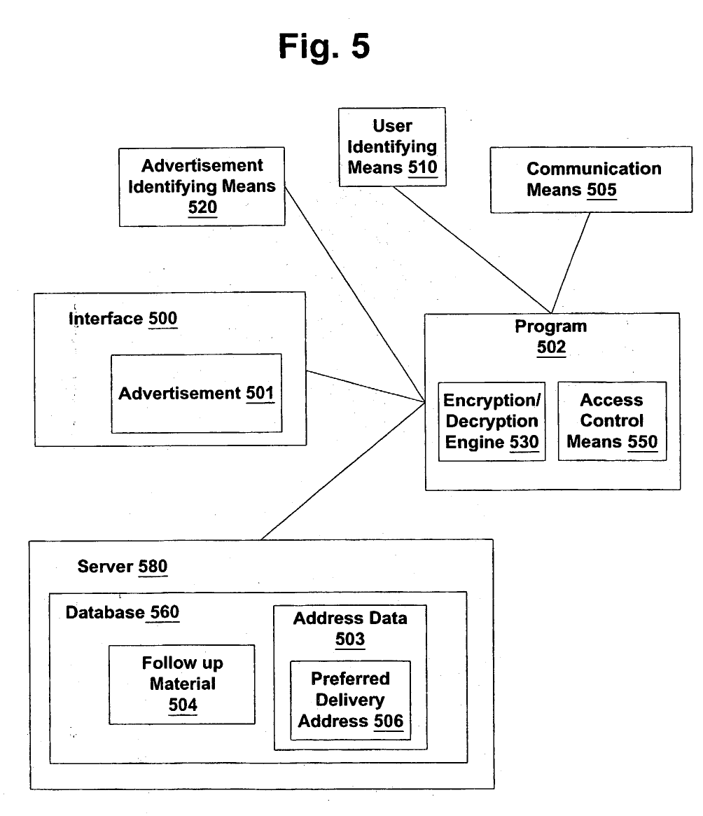

FIG. 5 illustrates a system in accordance with various embodiments of the invention. The system includes a user interface 500, an advertisement 501 (an embodiment of advertisements 101 or 300) conveyed to the user through the user interface 500, a program 502 responsive to user input, and a server 580 accessible by program 502. The server 580 includes a database 560 having address data 503 including preferred delivery address 506, and follow-up material 504 including information to be sent to address data 503 associated with a user. The system further includes user identifying means 510 accessible by program 502 and including telephone identification and cookies, communication means 505 accessible by program 502, and advertisement identification means 520 accessible by program 502.

The program 502 further includes an encryption/decryption engine 530 to protect personal information of a user, access control means 550 to control access to address data, means for changing the advertisement, and tracking means for logging activity of the system (not shown).

In one embodiment of the invention, database 560 includes a distributed database and program 502 includes code operating on server 580 and interface 100. Further, user identification means 510 includes a key to address data 503 and a telephone or interactive television identification.

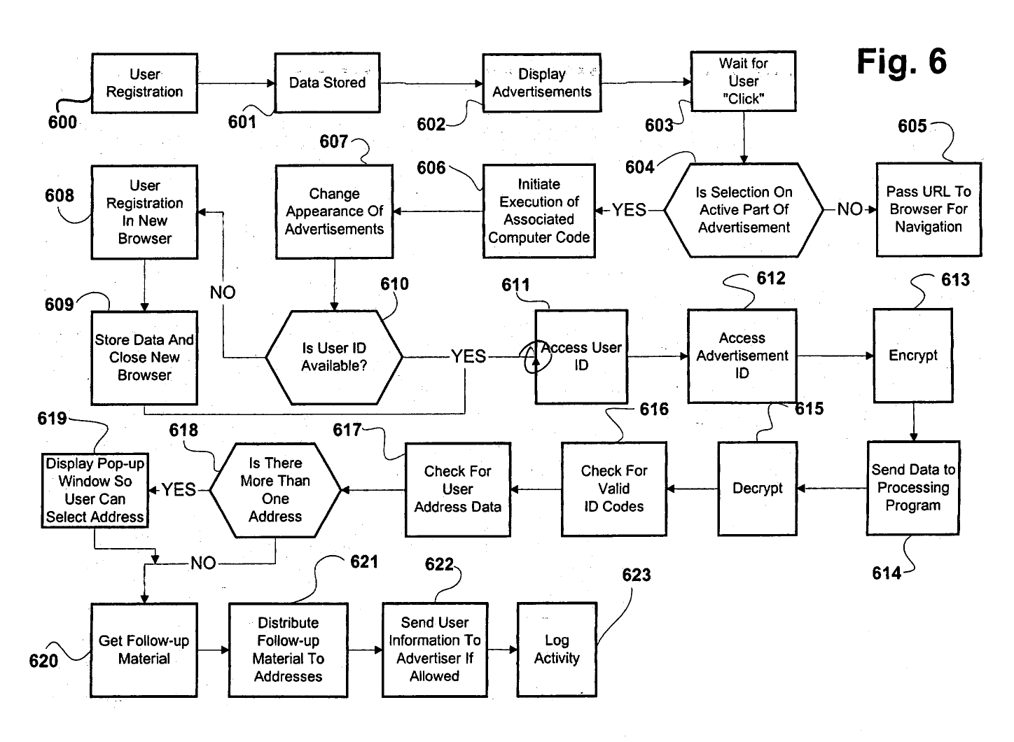

With reference to FIG. 6, a method in accordance with an embodiment of the invention is illustrated. In a optional step 600 a user performs a registration process either electronically or non-electronically. During the registration process the user provides a user alphanumeric identification used to identify and track the user's activities, the preferred delivery address 506, and a desired level of confidentially. Step 600 optionally further includes the provision of alternative message addresses, passwords, and further user information. Step 600 also optionally includes the provision of the user option of storing the identification on a user computer. In this form, the identification includes an encrypted cookie, processor identification, a file accessible by a browser plug-in, or the like. The registration process optionally includes communication over a secure Internet connection.

Address data 503 includes a type of address to which data can be sent including e-mail, postal mailing, file location, ftp site, web page, telephone/FAX number, and the like.

Alternative desired levels of confidentially include: a) the user address may not to be revealed to any other party; b) the user address may only be revealed to advertisers whose advertisements the user has selected; c) the user address may be revealed to a select group chosen by the user or d) the user address may be made public. Alternative message address data 503 can also be entered and used for delivery of follow-up material 504. Alternative message address data 503 enables the user to select, at the time of a request, alternate address to which data may be sent.

Password access is provided to enable a user to change their address information or other data. Other personal information is optionally collected. For example, a user could request that advertisements for adult material be blocked or sent to an alternative address location. The system further includes functionality to-work in conjunction with filtering software such as “NetNanny” or “SurfWatch”.

Upon completion of the registration process, the collected data is stored in a step 601. In one embodiment of the invention the data is stored in a secure remote site, such as server 580, and distinct from the interface used by the user. The data is stored in a non-public manner with limited access.

In an embodiment of the invention an independent third party manages the data and storage location. Account information optionally includes means by which the user may change their registration information. Account information is sent to the preferred delivery address 506 when registration information is added or changed.

In an optional step 602 an advertisement 501 is displayed to the user. Step 602 is not dependent on the user registration and data storage process described relative to steps 600 and 601 and in one embodiment precedes user registration. The display occurs, for example, in the form of a banner or other type of advertisement 501 on a web page or television. Each advertisement optionally includes an identifier unique to a particular advertisement 501, advertiser, the specific location displayed, and/or to some other information available to the advertiser, such as a cookie or the like.

In an embodiment of the invention, the advertisement 501 includes at least two active areas as described with reference to interactive advertisement 300, the at least two active areas distinguishable one from the other through trademarks, colors, graphics, symbols, or the like. Further, the advertisement 501 optionally includes a conventional URL link, or the like, which directs the user to a new URL upon being selected.

In a step 603 the method in accordance with the invention waits for the user to click or otherwise select either an active area or the URL link. In a step 604, the user's selection is checked and if the user has selected the URL link, in a step 605 the URL is passed to the interface 500 for navigation and the method ends. Otherwise, the user has selected an active area and processing proceeds to a step 606 in which computer instructions associated with advertisement 501 are executed. These instructions first optionally change the appearance of the advertisement 501, in a step 607, to indicate to the user that the selection (click) has been accepted.

In a step 610 it is determined if user identification means 510 is available. If user identification means 510 cannot be found, then the registration process is executed in steps 608 and 609 in which the user registers and the user data is stored respectively. This registration process differs from that of steps 600 and 601, in that the user is given the option of entering an existing user identification in case they are already registered and the user identification means 510 was previously not properly stored for access by program 502.

In steps 611 and 612 the process accesses user identification means 510 and advertisement identification means 520 associated with the advertisement 501, respectively. In an optional step 613 these data are encrypted, along with an authentication code, using encryption/decryption engine 530. In alternative embodiments part or all of encryption/decryption engine 520 is located on server 580 or a client associated with interface 500. The encrypted data is sent, in a step 614, over the Internet to a trusted party operable to decrypt the data, using encryption/decryption engine 530. In a step 615 the data is decrypted. The trusted party confirms the authentication code in a step 616 and in a step 617 the trusted party queries address data 503 in database 560 and collects the correct user address information based on the user identification means 510. If, as determined in a step 618, more than one preferred address is specified, a small pop-up window is optionally displayed in a step 619 on the interface 500 asking the user which addresses to use. In an embodiment of the process, information can be sent to more than one delivery address.

In a step 620, the trusted party queries database 560 and collects follow-up material 504 to be sent, based on the advertisement identification means 520 and the type of user address. The material is then sent to the one or more delivery addresses (e.g., Preferred Delivery Address 506)in a step 621. If the user has given permission, then the user's address information is also supplied to the advertiser in a step 622. Finally, in an optional step 623, the activity is logged. This log file is used for billing the advertiser and can be made available to the user so that they can monitor their own activity. Logging information may include the advertisement shown, the location of the advertisement, or the other advertisements the user has visited.

While particular embodiments of this invention have been shown in the drawings and described above, it will be apparent, that many changes can be made in the form, arrangement and positioning of the various elements of the combination. In consideration thereof it should be understood that embodiments of this invention disclosed herein are intended to be illustrative only and not intended to limit the scope of the invention.

Described below are numerous alternative embodiments of this invention that further illustrate the invention's use in various advertising media. It should be appreciated that a number of the terms used in this document can be defined in ways that constitute different embodiments, but all such embodiments are deemed to be within the scope of the appended claims.

Data and follow-up material 104 or 504 can take the form of advertisements, product information, products or services, programs, images, audio, video, text, printed material, magnetic tape, information conveyed on any other forms of data storage media or the like.

Advertisements 101 or 501 can take the form of display ads, audio, video, text graphics, rich media or any other forms of advertising display technology. Further the advertisements 101 or 501 include hyperlinks, buttons, or any other media that allows a user or potential customer to ask for further information or request a product.

Advertiser refers to either the entity placing the advertisement 101 or 501 and/or third parties acting as an agent/or on behalf of the entity placing the ad, or the web site, video stream, or audio stream on which the advertisement 101 or 501 is displayed.

The interface 100 or 500 includes the medium by which an interactive advertisement (e.g., advertisement 100 or 500) is presented to the user. The interface 100 or 500 includes a web browser, a web page, a voice mail system, a software or hardware program, a computing device, a sound system, an interactive television(screen, a wireless device, a display screen, printed matter, or any other interactive communication device that includes the means by which an interactive advertisement is delivered.

The term click applies to using a mouse or other input device to select an item on a computer screen or other type of electronic screen device for the purpose of delivering information to the user. Click also may include other means by which a user can make a selection. This includes touching, typing, speaking, looking toward, waiting a period of time, pushing a button, pointing with a device, and gesturing.

An address includes any location that data can be sent to and received, either electronically or physically, by a user. The address includes e-mail addresses, directories in a file system, files, postal mailing addresses, telephone numbers, FAX numbers, storage locations on interactive televisions, storage locations on interactive radios, private television channels, instant messaging handles, web pages, video, display screens, and other locating means for sending data.

Computers include such devices as personal computers, network computers, television top computers, interactive televisions, internet enabled televisions, interactive radios, personal digital assistants, telephones, cellular telephones, electronic books, beepers, internet enabled devices/appliances, and other devices for sending or receiving media and or information in electronic, audio or visual form.

Cookies refer to current technology that allows for identifying or tracking a specific user by means of placing a recognition file termed a cookie on the user's computer. Cookies also include alternative user identification means 510 including any other electronic data, voice or visual data, and code or script. User identification means also include any other means used for the purpose of recognizing Internet site visitors or users of other interactive media, such as dialing, vocal data, or electronic log in procedures. User identification means further include browser plug-ins, software programs, hardware programs, digital cable ids, DSL ids, IP addresses, caller ids, phone numbers, speech patterns, voice recognition, and processor, network, Ethernet identifiers or the like.

Internet communications broadly includes communications over networks, phone lines, wireless systems, direct electrical connections, and any system capable of transmitting digital data as well as live or delayed communications.

Program 102 or 502 includes a Java, or other programming language program, embedded code, compiled code, and script implemented in hardware or software. In various embodiments, program 102 or 502 also include hardware used to store a program or code. In some embodiments, program 102 or 502 further include client and/or server side applets and a browser plug-in.

Server 580 includes any computing device capable of supporting database 560 and aspects of program 102 or 502.

Embodiments of the invention involve media other than the Internet. Any advertising medium that allows user input can use the technology of the invention. These media include interactive television, radio, telephone, electronic newspapers, electronic books, electronic magazines, pagers, wireless communication devices, and the like.

In some embodiments of the disclosed system and method further are operable in information retrieval or delivery systems other than those that advertise a specific product or service. For example, the system and method can optionally be used as a registration system to sign up for an opt-in mailing list. In this case address data 103 or 503 of the user are added to the mailing list instead of being used to immediately deliver follow-up material 104 or 504.

In various embodiments of the invention, after an advertisement 101 or 501 is selected the advertisement is changed so that the user knows the click has been formally recognized. After a period of time (i.e. 3 seconds) an alternate advertisement 101 or 501 is displayed. Several different advertisements can be displayed without reloading a web page or otherwise reinitializing interface 100 or 500. In this manner the number of advertisements displayed is increased.

In some embodiments of the invention, advertisement 101 or 501 can include a timer indicating how much longer it will be displayed. At the end of the timed period a new advertisement is displayed in place of the advertisement 101 or 501. In this manner the number of advertisements displayed is increased. In an embodiment of the invention the new advertisement; is downloaded before or during the display of the advertisement 101 or 501. Program code 102 or 502 associated with the advertisements optionally controls this process.

Although a purchase is not required by the system and method of the invention, in one embodiment of the invention, delivery options are dependent on a user profile. The delivery options are optionally responsive to user income or user history. For example, a user with a history of frequent purchases or high income receives follow-up material 104 or 504 including a fancier, more expensive, brochure mailed to them. Alternatively, a user with a history of frequent purchases or high income may get a delivery by faster shipping method. Furthermore, the sender of follow-up material 104 or 504 bills for rapid FedEx™ delivery or other delivery options.

In various embodiments of the invention, the sender of follow-up material 104 or 504 sends an entire product instead of just follow-up material. In this case the user is billed using pre-registered information. In this embodiment of the invention, database 560 is managed by an independent third party, thereby providing site-independent single click purchasing. The single click purchase can be made from any interface 100 or 500 on which an advertisement 101 or 501 is shown. For example, the single click purchase can be made from any independent web site displaying advertisement 101 or 501.

In some embodiments of the invention, security certificates are used to assure the integrity of user identification means 510. Security certificates include public key encryption, a one-way hash, or any of the many available encoding methods.

In various embodiments of the invention, the request for information comes from the user in the form of an automatically generated e-mail. An automatically generated e-mail is differentiated from the execution of a standard mailto function in several ways. These include, for example, the elimination of several user actions, use of an advertisement identification means 520 and a user identification means 510, and the resulting automated delivery of follow-up material 104 or 504 related to an advertisement 101 or 501. The eliminated user steps include the following: having to view an e-mail client window, having to enter text or information into an e-mail client, having to push a button or execute a command to send the mail to an outbox or to an e-mail server, having to send mail from the outbox to an e-mail server, and having to transfer the mail from an electronic device to a computer capable of communicating e-mail. Automatically generated e-mail is optionally implemented by computer instructions that place an appropriate file in a user's outbox.

Selecting an advertisement 101 or 501 is accomplished through methods other than clicking directly on the advertisement. These methods include, for example, a custom browser button or menu item, an interactive TV button (remote or on set) or menu item, and any other input device used to interact with the interactive interface 100. These include devices that are used to point to a specific region on a screen or at a specific display or item.

In various embodiments of the invention, customer information is administered. This administration includes the confidential sharing of information between several independent entities offering advertisements 101 or 501 using the system and method of the invention. If several entities are all registering users, or collecting other information, there are times when each entity wishes to keep it's own information confidential but at the same time there is an advantage to making selected information available for use by all parties. Each entity registering users wants to keep the actual user information confidential because this information can have value for other purposes. However, the entities also benefit from sharing information such that users do not have to register with every entity or advertiser offering advertisements 101 or 501. Other examples of applications with similar needs include, for example, electronic wallets, instant messaging, medical reporting, storage of user preferences, user browsing habits, and the like.

In various embodiments of the invention, a method is provided to enable a single user registration which satisfies the registration needs of all parties. This is done without revealing the registration information to all of the parties. Some parties are able to use the registration information without knowledge of the information's details. Advantageously, the party that initiated the registration need not share all information about a user with competitors. Further a single registration can be shared between many parties and, as such, the value of registrations is increased for all. parties.

The following example illustrates this embodiment of the invention. First assume that the systems and method of the invention are implemented by four different parties Companies A, B, C and D whose business it is to supply banner advertisements to web sites. A user clicks on a banner advertisement 101 or 501 supplied by Company A and registers her e-mail address. Company A or an independent fifth party controls the registration window. The confidential e-mail address is sent directly or through Company A to the fifth party. A cookie is stored on the user's computer as a user identification means 510. Later, when the user responds to an advertisement 101 or 501 supplied by Company B, Company B receives an advertisement identification means 520 associated with the advertisement 101 or 501 and the user identification means 510 associated with the user. Company B then forms a message that includes the material to be sent to the user and the user identification means 510. This message is sent to the independent fifth party. The fifth party then uses the user identification means 510 to determine the user's preferred messaging address and sends follow-up material 104 or 504 on to that address. User identification means 510 can be converted to actual messaging addresses either through a look-up table, decryption of information contained within user identification means 510, or both.

Through this approach it is possible to hide the confidential user's messaging address from all parties other than the user and the fifth party.

Further security is available through the use of a registration window, in which the user enters their preferred messaging address, that includes a script or program that encrypts the address using a public key or other encryption algorithm. The only decryption is performed by the fifth party just before sending requested information to the user. In this manner the messaging address is never stored, anywhere, in a non-encrypted form. This greatly increases the security of the user information.

The described method of increasing security can be employed with data other than the user's preferred messaging addresses. For example, increased security can be provided to information regarding credit cards, social security numbers, addresses, phone numbers, medical information, browsing history, usage history, and the like. As used herein, usage history optionally includes any information about the user or use of the current interactive media, or any information about the device used to access the media.

The described method is, therefore, optionally applicable to other applications including e-commerce transactions wherein monetary media such as credit cards are used. For example, when a credit card purchase is made on the Internet it is common for the seller to store the credit card information on their computers. If this information is encrypted before it leaves the user's computer it is much safer. Decryption only occurs when information is sent to the bank, credit card company, or other end user. At each stage in the processing of the information, it is also possible to decrypt and re-encrypt with a new key in a segmented manner that assures that the user's personal information is never fully decrypted until it reaches the credit card company or other end user.

User registration, such as occurs in step 600, optionally includes a wide variety of information beyond a simple messaging address. Applications of such registration includes e-wallets, instant messaging, and the like.

An added advantage of having a third party decode user identification means 510 into a messaging address or other information is that it is easier to prevent spoofing of the system with fake requests. Each entity licensed to use the system of the invention or access database 560 has a unique identification or certificate that assures that a request to send information originates from a reliable source. Further, having a third party decode user identification means 510 into messaging addresses or other information enables the decoding in other than real- time. No immediate response to the user is required. Since reasonable delays are possible, the queuing and processing of requests can be organized in a much more efficient manner.

Another advantage of having a third party decode user identification means 510 into messaging addresses is that the process of fulfilling the customer's request is distributed over multiple computer resources. This maximizes the use of each piece of equipment and prevents the overloading of any single resource.

In various embodiments of the invention, a user has more than one user identification means 510. For example the user identification means 510 associated with an Internet browser on a computer is optionally different than the user identification means 510 associated with a television remote. Multiple household members also have their own unique user identification means 510. In this embodiment of the invention program 102 or 502 distinguishes user identification means 510 when there are multiple users and user identification means 510 sharing the same device. This is accomplished through any of the following means: a pop-up window that allows users to enter an identifying text or password; a pop-up window that allows users to select from a-list; a menu option that lets users select from a list (the menu option may be accessed through a right-click or a new or existing interface browser button.); and a user log-in profile. When the computer is an audio interface, such as a cellular phone, voice recognition is optionally used for identification. Different active areas of an advertisement 101 or 501 result in responses using different user identification means 510.

In various embodiments of the invention, a user chooses the method of information delivery each time a request for follow-up material 104 or 504 is made. For example, the user chooses between delivery by e-mail or post. This choice is made through standard input mechanisms such as a small pop-up browser window. Alternatively it is made through unique means including new menu items on the menu shown in a browser when an item is right-clicked, new browser buttons, and selection of different areas of an advertisement 101 or 501.

The availability of menu options and other selection devices such as buttons is a function of advertisement identification means 520. The availability of delivery options can alternatively be a function of the advertisement identification means 520. For example, not all advertisements 101 or 501 optionally allow delivery of material by post or different regions within an advertisement 101 or 501 may result in different delivery options when selected.

In some embodiments of the invention, a caller id telephone number or cellular account number is used as a user identification means 510.

In various embodiments of the invention, an advertisement 101 or 501 can be included as an attachment or component of an e-mail or other message. Thus, the response to an advertisement 101 or 501 that includes an email, optionally includes another advertisement 101 or 501 within the e-mail.

In various embodiments of the invention follow-up material 104 or 504 includes information or code that allows the follow-up material 104 or 504 to be stored in a convenient manner. For example, follow-up material 104 or 504 includes a keyword index that allows it to be searched and sorted more easily by an independent program. Alternatively, follow-up material 104 or 504 is automatically stored in a specific file directory after delivery. In one embodiment, a message client (program) is used to examine the messages and utilize information or code within the messages to sort, organize, retrieve, and more quickly examine the contents of the messages.

In various embodiments of the invention, follow-up material 104 or 504 is customized and individualized. For example, follow-up material 104 or 504 includes a coupon or discount code that enhances an economic transaction for the recipient. Follow-up material 104 or 504 optionally includes an affiliate or message identification that identifies the source of any transactions that later result as a consequence of the message. Follow-up material 104 or 504 optionally includes functionality that allows users to directly place an order for a product or service. Ordering is accomplished by the user executing a “single click” or by replying to the message. These capabilities are all important in measuring the effectiveness of the original advertisement. Further, examples of these capabilities are set forth herein.

In various embodiments of the invention follow-up material 104 or 504 includes a coupon that offers a discount on a product or service. This discount is optionally customizable in each follow-up material 104 or 504 sent. For example, some of the customizable features may include the amount of a discount, the available time period, and where the discount may be claimed. These features are determinable based on factors that are known about the individual user, such as past history, or on factors that are known about the advertisement 101 or 501 that generated the request for follow-up material 104 or 504, such as the advertisement 101 or 501 content and its location. In one embodiment, the coupon includes a unique identifier or code that identifies it. When the coupon is used, the transaction is associatable with all components of the process including the user, advertisement 101 or 501, and place where the advertisement 101 or 501 was displayed. Thus, both on and off-line buying patterns of the user can be associated with information about their browsing or viewing habits and their advertisement response habits.

In some embodiments, follow-up material 104 or 504 provides unique aspects relating to the way the coupon is delivered. The user can request the coupon with a single-action “click” on the follow-up material. In this manner an advertiser is provided with the ability to track the effectiveness of advertisements completely.

In various embodiments of the invention, an advertisement 101 or 501 posted on a display medium, such as a web page, provided by an “affiliate” to a primary merchant, such as a web site, can be identified as coming from the affiliate's medium. Based on these identifications commissions are optionally paid. Further, a cookie associated with the specific affiliate program need not be placed on the customer's computer. The affiliate displaying the advertisement 101 or 501 also need not provide a link directly to a primary merchant's web site. Instead there may be no link, or a link may be in the message delivered or an associated coupon. This is an advantage to the affiliate since it prevents customers from being directed away from their site. This feature allows affiliate relationships and customer referral systems to operate from any information source related to the invention such as an advertisement 101 or 501. Further, the affiliate need not be registered as an affiliate directly with the primary merchant. For example, the affiliate could be registered with the manager of the database 560.

In another example, the affiliate information need not be transmitted directly to the primary merchant. Furthermore, since the affiliate information is optionally encoded into the advertisement identifier, it is possible that only the manager of database 560 to know the identity of the affiliate. The affiliate need not include a specific link on their web site. The affiliate web site need not be reprogrammed to accommodate the affiliate relationship. The affiliate transaction need not be associated with an electronic or non-electronic purchase. And, the affiliate identity need not be disclosed to the primary merchant. In this manner an affiliate program can be established without being restricted to computer networks and hypertext media. As described herein the systems and methods of the invention are optionally used to establish affiliate relationships through interactive media.

In some embodiments of the invention a request for follow-up material 104 or 504 does not necessarily result in a reloading of a new interface 100 or 500 image, page, or other material. Therefore, confirmation of a selection can be made by executing software code that is already loaded as part of the advertisement display or audio. An advertisement 101 or 501 need not be tied to a specific item shown on the current interface. The functionality of the invention need not be “enabled” by the user and an associated flag to indicate an on/off condition need not be used.

In various embodiments of then invention, a response to an advertisement such as an advertisement 101 or 501 need not involve a purchase or financial transaction. Advertisement 101 or 501 can be interchangeable with other standard advertisements such as standard sized Internet banner advertisements. Their use, therefore, does not require re-coding of the advertising pages.

A wide variety of user activities are optionally tracked and logged using various embodiments of the invention. In one embodiment of the invention, the user is allowed to select the degree to which information is recorded and how it is used.

In some embodiments of the invention users are provided with “login” capability giving them access to and the ability to change their settings, preferences, and history. Information about this ability can be delivered to the preferred delivery address 106 or 506 after registration.

In other embodiments of the invention the system and method enhance advertising functionality on checkout (point of purchase) video displays, gas station pump video displays, airplane/bus and other transportation-based video displays, electronic games, video games, electronic books and magazines, electronic picture frames, electronic maps, computer interfaces, screensavers, push technology information systems, and kiosks, electronic control panels, software advertisements such as those imbedded in shareware products like pkzip.exe. These media display devices also include advertisements running along the edge of television screens, computer screens, browser windows, or other display devices.

In some embodiments, it is not necessary that user identification means 510 be stored electronically. For example, some point of purchase systems now display video messages to customers while they are waiting. Examples include some gas station pump units and displays at checkout lines. With these systems the user may desire to just type an identification number onto a keyboard or swipe a credit card. The identification number or credit card number are used as user identification means 510 and follow-up material is provide as described above.

The communications networks used for credit card verification are optionally used as communication means 105 or 505 in various embodiments of the invention.

An advantage gained in various embodiments of the invention is that the user is not required to reveal confidential information such as a telephone number, email, or postal mail address. Optionally, user identification means 510 can only be used in conjunction with valid advertisement identification means 520. Thus, the source of spam or unwanted material can be identified and blocked. The user identification means 510 is thus made useful only to entities presenting proper advertisements 101 or 501. A user is much more likely to provide a user identification than an e-mail address. For added confidentiality users optionally can change their user identification means 510. User identification means 510 is much more convenient to change than an e-mail or postal mailing address.

In various embodiments of the invention, functionality is provided for looking for the user identification means before displaying the advertisement. For example, if the user is not registered, the advertisement 101 or 501 can include text asking the user to register at that time or other text describing how the disclosed system and method operates or benefits registered users. In contrast, if the user is registered, the advertisement 101 or 501 includes text showing the user's preferred delivery address 106 or 506, or part thereof. If the user using an interface is registered with multiple preferred delivery addresses 106 or 506 or multiple user identification means 510 are available (as with several users using the same device), the advertisement 101 or 501 includes a separate, active area for one or several of the user identification means 510 or preferred delivery addresses 106 or 506. Each active area includes means for indicating which address it is associated with. A user can, therefore, select the preferred delivery address 106 or 506 by clicking on a specific active area of the advertisement 101 or 501. This embodiment of the invention can optionally be used to eliminate the need for steps 618 and 619 of FIG. 6.

In some embodiments of the invention, the registration process optionally allows the user to designate that a “public” or multi-user computer is being used. In this case an additional “password” and/or user “name” request step is used in the information request process. This step is>implemented in a new pop-up window, thus minimizing the interruption of the user's activity.

In various embodiments of the invention, material is delivered with return receipt requested.

Advantageously, the disclosed system and method enable the ability to perform a request for advertising material without interrupting the user's current activity. The disclosed system does allows a user to express interest in an advertisement and receive information without being directed a new location or reload the material in the interface. This is of great value since it reduces the time and effort cost of the user selecting an advertisement. Secondly, the process is site independent. The user's address data is stored at a location that is not necessarily related to the location at which the advertisement is displayed and the request is made. This independence provides a number of great advantages including the ability to display the advertisement on any site, confidentiality to the user, and enables the ability to display an advertisement in place of a normal standard advertisement without any changes to the coding of a web site displaying the advertisement.

In some embodiments, advertisement 101 or 501 is a single display or text advertisement that includes at least one active area having different functionality. This is differentiated from two advertisements placed side by side, in part, because advertisement 101 or 501 only requires one reference in the referring web page. It also allows flexibility in the relative sizes of the active areas of advertisement 101 or 501. Without further coding, the size of these areas could not be changed on a per advertisement basis if two separate advertisements were used side by side.

In various embodiments of the invention, advertisement 101 or 501 is contained within an e-mail message. Thus, an e-mail response from an advertisement 101 or 501 may include another advertisement 101 or 501. This recursive relationship is also enabled in other delivery methods.

In various embodiments of the invention, advertisement 101 or 501 is included in electronic newsletters, e-zines, electronic magazines or other information services that use electronic media.

In some embodiments of the invention, advertisement 101 or 501 is included in audio and video files or the software and or hardware that are used to broadcast or play these files. These files include formats such as Stream, Streaming, Audio, Video, ASF, ASX, MPEG WAV, AVI, MIDI, MOV, VOD, AU, MP3, and QuickTime. The software or hardware used includes Real Audio, Windows radio, Windows Media, and Radio Toolbar, and player systems such as that offered by RealNetworks and Microsoft (Microsoft Media Player and Digital Broadcast Manager).

In various embodiments of the invention, advertisement 101 or 501 is included on display devices such as those offered by Netpulse Communications, Inc. These include display terminals related to exercise equipment and at point of purchase locations. It is typically a characteristic of these devices that they do not have a method for users to download and save information. The disclosed system and method of the invention advantageously solve this problem.

In some embodiments of the invention, information is delivered, at a user's option, in a batch mode. This has the advantage that the number of deliveries is reduced.

In various embodiments of the invention, users make site independent purchases in addition to requesting free information. User identification means 510 is used to identify purchasers and log transactions including debits and credits to accounts. Also, users are given the option of editing information relating to their registration. The editable items include preferred delivery addresses 106 or 506, delivery options, billing, and privacy options.

I claim:

48. (New) A method for providing information to a user in response to a user request, the method comprising the steps of:
displaying an object, the object including a selectable area;
receiving the user request responsive to selection of the selectable area;
retrieving a stored user delivery address;
retrieving information associated with the selectable area; and
delivering the information to the user delivery address.

49. (New) The method of claim 48 wherein the object further comprises an advertisement.

50. (New) The method of claim 49 wherein the advertisement is displayed on a computing device.

51. (New) The method of claim 49 wherein the advertisement is displayed on a wireless telephone.

52. (New) The method of claim 49 wherein the advertisement is displayed on a television.

53. (New) The method of claim 49 wherein the object further includes an image.

54. (New) The method of claim 49 wherein the user delivery address is stored in a database.

55. (New) The method of claim 48 wherein the user delivery address is retrieved without further user input.

56. (New) The method of claim 48 wherein the object further includes an audio component, is displayed as an audio stream, and the selectable area is a time period in the audio component.

57. (New) The method of claim 48 wherein the object further includes a plurality of selectable areas.

58. (New) The method of claim 57 wherein each of the plurality of selectable areas is associated with a responsive function.

59. (New) The method of claim 48 wherein the user delivery address is retrieved from a location accessible to a recipient of the user request.

60. (New) The method of claim 59 wherein the recipient of the user request includes an entity independent of an entity displaying the object.

61. (New) The method of claim 48 wherein the user delivery address includes an address of an interactive television.

62. (New) The method of claim 48 wherein the user delivery address includes an e-mail address.

63. (New) The method of claim 62 wherein a user identifying means is used to retrieve the user delivery address.

64. (New) The method of claim 63 wherein the user identifying means further comprises a telephone identification.

65. (New) The method of claim 63 wherein the user identifying means includes a television device identification.

66. (New) The method of claim 63 wherein the user identifying means includes a cookie.

67. (New) The method of claim 63 wherein the user identifying means includes a processor identification.

68. (New) The method of claim 48 wherein the information retrieved includes video.

69. (New) The method of claim 48 wherein the information retrieved includes audio.

70. (New) The method of claim 48 wherein the information retrieved includes~a coupon.

71. (New) The method of claim 48 wherein the information is retrieved other than in real time.

72. (New) The method of claim 48 wherein the information is delivered to the user in other than real time.

73. (New) The method of claim 48 wherein the information is delivered to a television device.

74. (New) The method of claim 48 wherein the information is delivered to the user without a purchase.

75. (New) A system for providing information to a user in response to a user request, the system comprising:
a user interface;
an object displayable on the user interface and selectable using an input device;
a program operable to receive the user selection;
address data associated with the user;
information associated with the object; and
a device operable to deliver the information to the address data.

76. (New) The system of claim 75 wherein the object is an advertisement.

77. (New) The system of claim 76 further comprising an object identifying means configured to associate the information with the object.

78. (New) The system of claim 76 further comprising a user identifying means configured to look up the address data stored in a database.

79. (New) The system of claim 78 wherein the user identifying means further comprises a telephone identification.

80. (New) The system of claim 78 wherein the user identifying means includes a television device identification.

81. (New) The system of claim 78 wherein the user identifying means includes processor identification.

82. (New) The system of claim 76 further comprising a computing device configured to store the information.

83. (New) The system of claim 76 wherein the user interface includes a television device.

84. (New) The system of claim 76 wherein the user interface includes a web browser.

85. (New) The system of claim 76 wherein the user interface further comprises a telephone.

86. (New) The system of claim 85 wherein the object includes an audio stream.

87. (New) The system of claim 76 wherein the object includes a plurality of selectable inputs.

88. (New) The system of claim 87 wherein the selectable inputs include selectable areas.

89. (New) The system of claim 76 wherein the program includes an encryption/decryption engine.

90. (New) The system of claim 76 wherein the program includes an access control means.

91. (New) The system of claim 76 wherein the address data further comprises a plurality of address associated with a user.

92. (New) The system of claim 76 wherein the input device includes a wireless device.

93. (New) The system of claim 76 wherein the input device includes an audio device.

94. (New) A method for providing information to a user in response to a user request, the method comprising the steps of:
displaying an advertisement, the advertisement responsive to a selectable input;
receiving the user request responsive to selection of the selectable input;
automatically retrieving a previously stored user delivery address;
retrieving information associated with the advertisement; and
delivering the information to the user delivery address.

95. (New) The method of claim 94 wherein the selectable input includes a button.

96. (New) The method of claim 95 wherein the button is a telephone button.

97. (New) The method of claim 95 wherein the button is a television control device button.

98. (New) The method of claim 95 wherein the button is a graphical interface pointing device button.

99. (New) The method of claim 94 wherein the selectable input includes a voice recognition process.

100. (New) The method of claim 94 wherein the selectable input includes a wireless device.

101. (New) A system for providing information to a user in response to a user request, the system comprising:
a user interface;
an advertisement displayable on the user interface and selectable using an input device;
follow-up material relating to the advertisement; and
means for automatically delivering the follow-up material to a previously stored user delivery address in response to selection of the advertisement.

102. (New) The system of claim 101 wherein the means for automatically delivering the,follow-up material are independent of a web site on which the advertisement is displayed.

103. (New) The system of claim 101 wherein the advertisement is displayed on a television device.

104. (New) The system of claim 101 wherein the advertisement is displayed on a wireless device.

105. The system of claim 104 wherein the wireless device is a telephone and the display is audio.

106. (New) A method for providing information to a user in response to a user request, the method comprising the steps of:
displaying an advertisement, the advertisement including a selectable input;
receiving the user request responsive to selection of the selectable input;
retrieving a user delivery address;
retrieving information associated with the selectable input; and
delivering the information to the user delivery address in such manner that the user can select when to view the information.

107. (New) The method of claim 106 wherein the information is delivered as e-mail.

108. (New) The method of claim 106 wherein the information is delivered as video.

109. (New) The method of claim 108 wherein the information is delivered to a digital VCR.
